(19) United States
(12) Patent Application Publication
(10) Pub. No.: US 2014/0325338 A1
(43) Pub. Date: Oct. 30, 2014

(54) DISPLAYABLE CONTENT INSERTION SYSTEM

(71) Applicant: Yadwire Technologies Ltd., Ra'anana (IL)

(72) Inventors: David ZIZA, Tel Aviv (IL); Stephane HERCOT, Ra'anana (IL)

(21) Appl. No.: 14/249,381

(22) Filed: Apr. 10, 2014

Related U.S. Application Data
(60) Provisional application No. 61/815,477, filed on Apr. 24, 2013.

(51) Int. Cl. G06F 17/22

(52) U.S. Cl. CPC G06F 17/2247
USPC 715/234

(57) ABSTRACT

A system for inserting displayable content into a web page for displaying on a communication device is described. The system includes a displayable content provider in communication with the communication device over a communication network and operable to adjust a display format of the displayable content responsive to a call from the communication device. The system additionally includes a communication network access device connecting the communication device to the communication network and including an injection unit to inject calling instructions into the web page prior to displaying the web page on the communication device.

### CROSS-REFERENCE TO RELATED APPLICATIONS

This application claims benefit from U.S. Provisional Patent Application No. 61/815,477, filed 24 Apr. 2013, which is hereby incorporated in its entirety by reference.

### FIELD OF THE INVENTION

The present invention relates to web browser pages generally and to a system and method for inserting displayable content in web browser pages downloaded by communication devices in particular.

### BACKGROUND OF THE INVENTION

Wi-Fi hotspots are typically establishments that offer Internet access over a wireless local area network (WLAN) through a router connected to a link to an Internet service provider (ISP). Hotspots are often found at restaurants, train stations, airports, libraries, hotels, hospitals, coffee shops, bookstores, fuel stations, department stores, supermarkets, campgrounds, public payphones, and other public places. Many universities and schools also have wireless networks in their campus.

Wi-Fi hotspots typically operate in one of two ways; as free hotspots where any user generally within the range of a router or any other type of communication network access device may connect through the network access device to the Internet free of charge, or as commercial hotspots where a user may be required to pay for connecting to a web browsing session. Frequently, the hotspots use a captive portal/login screen to which users are redirected when they first connect to the network access device. These captive portals generally include advertising and other displayable content through which an owner of the hotspot may promote himself or others, and may offer products and/or services.

Associating advertising and other displayable content with web browser pages (web pages) is a source of revenue for ISPs and for web site owners (operators) who generally provide access to their web sites free of charge. The displayable content is generally inserted into the web pages and is typically prearranged into display formats which conform to space allocations (placeholders) provided by the website owners in the web pages. Frequently, the displayable content is provided by third party displayable content providers, although the displayable content provider may also be the web site owner or the ISP.

Methods and systems are known in the art for inserting displayable content into web browser pages. The displayable content may include many different types of textual and/or visual images which may be associated with a location of a user of the device, with browsing preferences of the user, with a pre-established profile of the user, with an advertising promotional campaign, among other criteria which may be used to determine the displayable content to be inserted. For example, a device connected through a wireless communication network (e.g. Wi-Fi) of a coffee shop to the Internet may have displayable content inserted into the web pages in the form of advertising associated with the establishment, while if connected through the wireless communication network in an airport, the displayable content may be associated with airport services, possibly including information related to flight schedules, bag collection, and check-in counters, and/or with advertising associated with airport shops including restaurants, coffee shops, and bars.

Ong in US 2012/0246553 A1 describes “a method of causing a client device to display a designated web page includes receiving from the client device a request for a connection to a first web server, accepting the connection with the client device by pretending to be the first web server, and receiving via the connection a hypertext transfer protocol (HTTP) request. The method further includes retrieving content of the designated web page, modifying the content to form modified content having at least some original content of the designated web page preserved, and replying to the client device via the connection with an HTTP response including the modified content.”

Kassab in WO 2005/114449 A2 describes “methods and systems are provided for filtering content into a web page and provided the modified web page to a web browser (801). A request for a web page is intercepted and redirected to a web page processing agent (811), which fetches the requested web content. New web page is generated that includes the requested web content and inserted content provided from another source, such as from an ISP. The inserted content is presented in a dedicated screen area. The new web page may include a first frame comprising the inserted content and a second frame including the requested web content, such that the end user can scroll the web content without affecting the inserted content.”

Aaltonen in WO 2009/043939 A1 describes a “system, method and computer program for associating displayable data, such as advertisements, with Web and WAP pages being delivered from Internet or mobile services to mobile or fixed terminals via a communications network. An intermediate box, which may take the form of, or be resident in, a router, a proxy, a gateway, a server or other network element involved in routing Internet communications, analyzes communications related to Web or WAP browsing being directed to the mobile or fixed terminals and modifies part of the communications to include associated advertisements on Web or WAP pages or to add additional Web or WAP pages for information requests, e.g., interstitial pages.”

Other related art include EP 2 003 608 A1, US Publication No. 2010/01065725 A1, and US Publication No. 2011/0302033 A1.

### SUMMARY OF THE PRESENT INVENTION

There is provided, according to an embodiment of the present invention, a system for inserting displayable content into a web page for displaying on a communication device including a displayable content provider in communication with the communication device over a communication network. The displayable content provider is operable to adjust a display format of the displayable content responsive to a call from the communication device. The system additionally includes a communication network access device connecting the communication device to the communication network and including an injection unit to inject calling instructions into the web page prior to displaying the web page on the communication device.

According to an embodiment of the present invention, the displayable content provider includes a server.

According to an embodiment of the present invention, the displayable content provider includes a database.

According to an embodiment of the present invention, the displayable content provider is operable to detect a display size of the communication device.

According to an embodiment of the present invention, the displayable content provider is operable to detect a width size of the web page.

According to an embodiment of the present invention, the displayable communication network access device is a router.

According to an embodiment of the present invention, the displayable communication network access device communicates with the communication device over a wireless network.

According to an embodiment of the present invention, the communication network includes the Internet.

According to an embodiment of the present invention, the calling instructions include a MAC (media access control) address of the communication network access device.

There is provided, according to an embodiment of the present invention, a method of inserting displayable content into a webpage for displaying on a communication device. The method includes requesting a web page from a web site; intercepting the requested web page; injecting into the web page calling instructions to a displayable content provider; and displaying the requested web page on the communication device following injection of the calling instructions.

According to an embodiment of the present invention, the method additionally includes calling the displayable content provider; determining a type of communication device responsive to the calling; adjusting a display format of the displayable content responsive to the determining; and inserting the displayable content into the requested webpage displayed on the communication device.

According to an embodiment of the present invention, the method additionally includes the displayable content provider determining a display size of the communication device.

According to an embodiment of the present invention, the method additionally includes the displayable content provider determining a font size of the displayable content responsive to the determining the display size.

According to an embodiment of the present invention, the method additionally includes the displayable content provider determining a width of the requested web page.

According to an embodiment of the present invention, the method additionally includes the inserting into the calling instructions a MAC address of a communication network access device.

According to an embodiment of the present invention, inserting the displayable content includes inserting an HTML strip into the requested web page.

According to an embodiment of the present invention, the displayable content is inserted on a side of the web page.

According to an embodiment of the present invention, the displayable content is inserted above the web page.

There is provided, according to an embodiment of the present invention, a communication network access device for connecting a communication device to a communication network. The communication device includes an injection unit for injecting calling instructions into a web page prior to displaying the web page on the communication device.

According to an embodiment of the present invention, the communication network access device includes a router.

According to an embodiment of the present invention, the communication network access device includes means to communicate with the communication device over a wireless network.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates an exemplary system for inserting displayable content in web browser pages downloaded by communication devices, according to an embodiment of the present invention;

FIG. 2 is a flow chart of a method for inserting displayable content in web browser pages downloaded by communication devices, according to an embodiment of the present invention;

FIG. 3 schematically illustrates an exemplary browser page before displayable content insertion;

FIG. 4 schematically illustrates the exemplary browser page of FIG. 3 following initial displayable content insertion, according to an embodiment of the present invention;

FIGS. 5A and 5B schematically illustrate the exemplary browser page of FIG. 3 in a partial mode and a final mode of side insertion of displayable content, respectively, according to an embodiment of the present invention; and

FIGS. 6A and 6B schematically illustrate the exemplary browser page of FIG. 3 in a partial mode and a final mode of top insertion of displayable content, respectively, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Advances in wireless communication technology and in web browsing technology allow many different types of communication devices such as for example, mobile phones, smartphones, laptop computers, tablet computers, and personal computers, to access the Internet and download web pages. The downloaded web pages were initially formatted for display on devices such as personal computers and laptops, where the whole width of the web page fits into the display of the devices. This display format allowed for viewing a whole web page generally using only vertical scrolling (up and down the web page) if the whole page did not fit in the display. This display format was incompatible with newer mobile devices (e.g. mobile phones, smart phones, and tablets) which have narrower displays and, as a result, scrolling to view a web page generally required both vertical scrolling and horizontal scrolling (to view contents along the width of the web page), or more generally the device may scale the whole web page down, which may influence readability and may require a reader to zoom into the page. In order to improve viewing of web pages with mobile devices, mobile versions of the web sites have been made available. These mobile websites allow downloading the web pages in a format which generally may be suitably displayed on the mobile devices, and which may only require using vertical scrolling if the whole page does not fit in the display.

Preparing displayable content for inserting into web pages is frequently time consuming and costly as the displayable content must conform to the display format of the requested web page, the web browser and of the displaying device. The displayable content must take into consideration whether the web page is viewed with a regular (non-mobile) web browser or a mobile web browser. It must also take into consideration that there are large variations between the sizes of the displays on communication devices so that the display content does not affect the proper fitting of the web page in each type of display. Additional considerations include the width of the web pages. This requires that displayable content providers prepare in advance displayable content in different display formats to correspond with different types and sizes of web pages and according to the types and display sizes of the communication devices. This is necessary so that properly formatted displayable content may be readily inserted into a webpage when the webpage is requested.

Applicants have realized that by acquiring information associated with a display size of the communication device and a width of a web page requested by the communication device, displayable content may be adjusted “on-the-fly” to a proper display format for insertion into any web page requested by the communication device. This may eliminate a need for a web site owner to carry an inventory of displayable content placeholders in different display formats as is common practice in the art. Applicants have therefore devised a server-based displayable content insertion system operable to determine the type and display size of the communication device requesting a web page, the type of browser used by the device, and the width of the web page requested by the communication device. Additionally, the displayable content insertion system is operable to have the displayable content inserted into the webpage being downloaded in the proper display format compatible with the browser and the communication device. Additionally, the displayable content insertion system is operable to identify the location of the communication device requesting the web page and to have displayable content associated with the location of the communication device inserted into the web page. The location may be, for example, a Wi-Fi hotspot establishment or other wireless network connected establishment through which the communication device connects to the system.

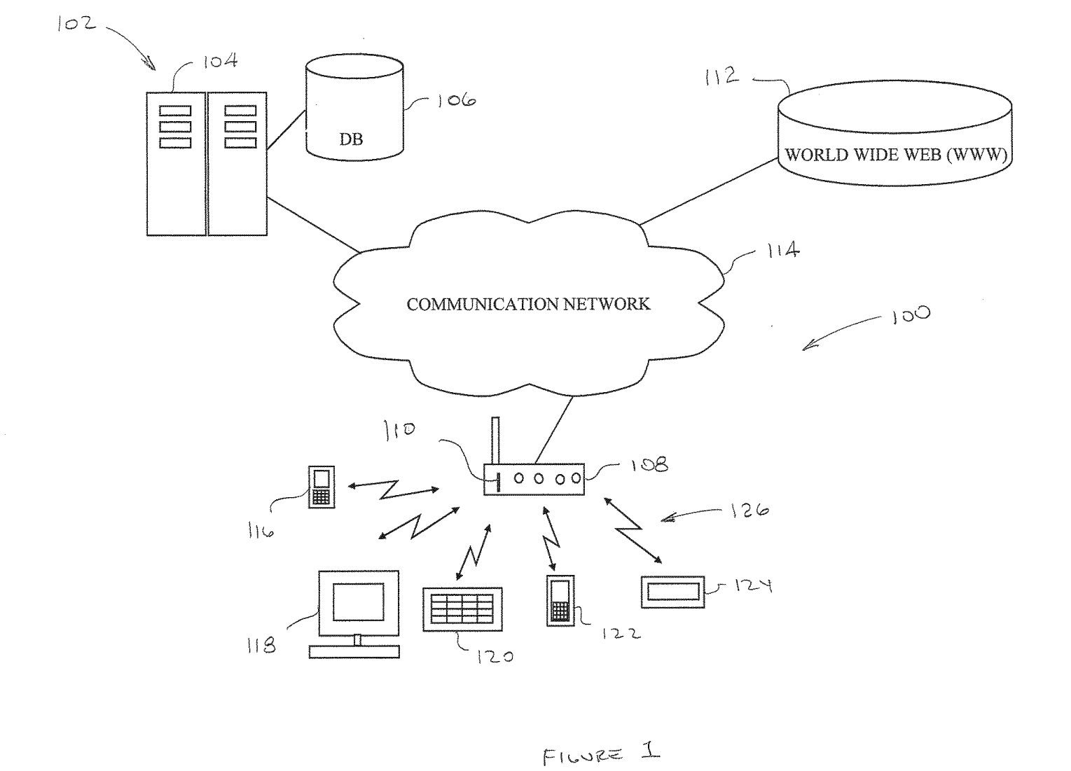

Reference is now made to FIG. 1 which schematically illustrates an exemplary system 100 for inserting displayable content “on-the-fly” into web browser pages requested by communication devices 116-124 from websites on the World Wide Web 112, according to an embodiment of the present invention. The displayable content may include any textual or visual content (also video), including advertising content. The websites may include regular websites and mobile websites. System 100 includes a displayable content provider 102 including a displayable content server 104 and a database 106, and a communication network access device 108, for example a router or server including an injection unit 110. Communication devices 116-124 may include non-mobile devices and mobile devices such as for example, a PC computer 118 (non-mobile), a laptop computer 120 (non-mobile), a mobile phone 116 (mobile), a smartphone 122 (mobile), or a tablet computer 124 (mobile).

Displayable content provider 102 may detect communication devices 116-124 and adjusts the display format of the displayable content stored in database 106 to conform to that of any web page requested by any of the communication devices, and to the type and display size of the communication devices themselves. Additionally or alternatively, the displayable content may be obtained from a third party displayable content provider or other suitable source, so that the displayable content not necessarily needs to be stored in database 106. The detection may be performed by displayable content server 104 using known detection techniques which may include analyzing the HTTP headers, including user agent headers, in the browsers of communication devices 116-124. Information regarding the different types of communication devices 116-124 to associate the communication devices with the HTTP headers may also be stored in database 106.

Displayable content provider 102 additionally may insert the adjusted displayable content into each requested web page for display on communication devices 116-124. The insertion may be performed by server 104 using known techniques which allow the browser in communication devices 116-124 to know the insertion location of the displayable content.

Displayable content provider 102 may identify the location of communication devices 116-124 through router 108. Identification of the location may be performed by server 104 responsive to receiving a MAC address of router 108.

Displayable content provider 102 may include means for implementing administrator functions such as creating and managing users of system 100, creating and managing networks, controlling insertion of displayable content into specific websites including preventing insertion if necessary, controlling display time of displayable content on a web page, overriding router functions, and creating and managing the displayable content. Means may be included for managing an upload interface for uploading images and flash animations, for managing a studio interface which may be used to create displayable content on templates and which may include means for filling forms to add text and action to the displayable content. Means may be included for managing a 3^{rd} content interface for adding 3^{rd} content JavaScript to be executed and iframe to be displayed.

Router 108 may be a wireless router and may connect communication devices 116-124 over a wireless network 126 to displayable content server 104 through communication network 114. Router 108 may be a hotspot router for a Wi-Fi network or for any other type of WLAN, or, for larger networks such as those covered for example, by WiMAX technology. Additionally or alternatively, one or more of communication devices 116-124 may connect to router 108 through a wired connection, for example, an Ethernet connection.

Injection unit 110 in router 108 may be implemented as firmware suitable for injecting (attaching) to each web page requested by communication devices 116-124 a script directly associated with the location of the communication devices. The firmware may be implemented as new firmware inserted into router 108, and may include modifying existing firmware in the router. Additionally or alternatively, injection unit may be implemented as a computer readable medium. The script may include a link or other type of calling instructions to server 104 through a transparent proxy. The script may include the MAC address of router 108 which is sent to server 104 and serves to identify the location of communication devices 116-124. The script may also call on JavaScript tools to gather information on the browser and the device. The firmware may be bundled with any Operating System (OS) that accepts third party (open source software) such as for example, UNIX, Linux, FreeBSD, among other known open source OS, and may include scripts for detecting the MAC address when router 108 is first booted on and may be injected into each web page requested by communication devices 116-124 and allows server 104 to identify the location of the communication devices. The firmware may additionally include numerous other scripts which may be associated with system 100 functionality, for example to send requests to server 104 at regular intervals to indicate to the server that the router is present (alive); or to check if any code has been set to be downloaded from the server and executed (this may be the case when injection unit 110 is to be controlled remotely). Additionally, the firmware may be extended with captive portal open source software which may allow server 104 to store MAC addresses which may be associated with communication devices 116-124 in addition to the MAC address of router 108.

Communication network 114 may include a wired network, a wireless network, or any type of communication network suitable to support communication between displayable content server 104 and router 108 and having access to websites on the World Wide Web 112, or any combination thereof. Communication network 114 may include the Internet.

One example of an application of system 100 may be to download advertising content to communication devices connected to the Internet through routers in establishments operating wireless networks (e.g. Wi-Fi hotspots). As system 100 knows the location of the communication devices, predetermined advertising content associated with the establishment may be inserted into the requested web pages. For example, the inserted advertising content may include the logo of the establishment, or other information on the establishment, or any other displayable content which may serve to advertise and promote the establishment.

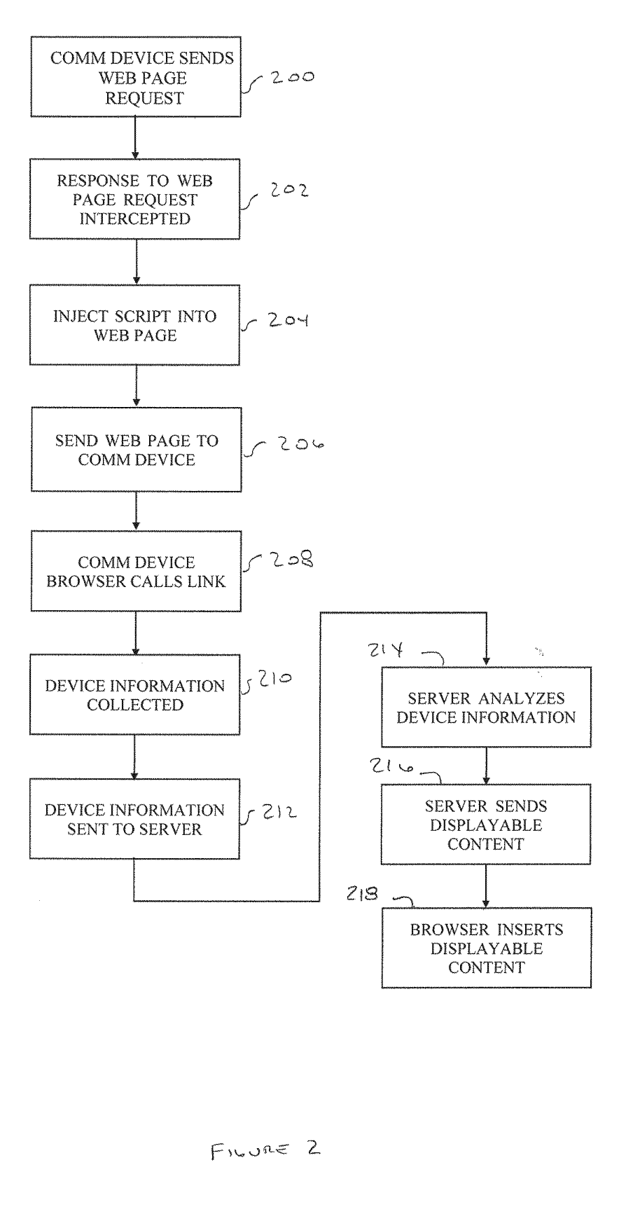

Reference is now made to FIG. 2 which is a flow chart of a method for inserting displayable content into web browser pages downloaded from the website on the WWW by communication devices, according to an embodiment of the present invention. For exemplary purposes, reference will made to system 100 shown in FIG. 1 and described above. The method, although described below in an embodiment of the present invention in steps 200-218, a person skilled in the art may realize that the method may be practiced with more or less steps, or with a different sequence of steps, or any combination thereof.

At 200, a communication device, for example, one of communication devices 116-124 may send a request to download a web page from a website on the WWW 112. The website may be a regular website or a mobile website.

At 202, the requested web page is intercepted by router 108.

At 204, a script is injected by injection unit 110 into the requested web page. The script includes the MAC address of router 108 and a transparent proxy link to server 104 in displayable content provider 102.

At 206, the requested web page is sent to the communication device and the webpage is displayed by the browser on the device's display.

At 208, the browser in the communication device calls the injected script and the proxy link to server 104. The script may include JavaScript tools or other known tools which may collect information related to the browser, the communication device, and the requested (now displayed) web page. The information may include HTTP header information, user agent information, flash enablement, operating system (browser and/or device), display size, language (device, browser and/or web page), time zone, time and date, among other information.

At 210, the information related to the browser and to the communication device is collected.

At 212, the collected information is sent from the communication device through router 108 over communication system 112 to server 104. The sent information includes the MAC address of router 108.

At 214, server 104 receives and processes the collected information. Server 104 may associate the collected information with data stored in database 106 to identify the type of communication device. Server 104 additionally requests from database 106 or from another suitable displayable content provider the displayable content which is to be inserted into the webpage. The displayable content may be selected based on predetermined criteria programmed in server 104. The predetermined criteria may include selecting displayable content associated with the location of the communication device and where router 108 is located. Server 104, based on the collected information, determines the display format of the displayable content. The display format may include sizing the displayable content according to the display size and the width of the displayed requested web page. This may include sizing text and images included in the displayable content so that they may be easily viewed by a user of communication devices 116-124.

At 216, server 104 sends the displayable content to the communication device through router 108. The displayable content includes the display format compatible with the requested web page, the browser and the communication device.

At 218, the browser receives the displayable content and creates a space in the web browser page for the displayable content. The browser inserts the displayable content into the web browser page which appears displayed on the device's display. Additionally or alternatively, the browser may execute a script, or may create an iframe and call on server 104 again to request displayable content. The insertion and display of the displayable contents may have numerous modes. The following may be some examples:

a. a space may be slowly created at the top of the displayed web page with the displayable content slowly appearing inside the space. The web page may return back to normal after a few seconds as may be predetermined by displayable content provider 102.

b. a space may be slowly created on the right side of the displayed web page with the displayable content slowly appearing inside the space. The web page may return back to normal after a few seconds as may be predetermined by displayable content provider 102. Alternatively, the space may be created on the left side of the displayed page.

c. the web page may be grayed out with the displayable content displayed in the center of the screen

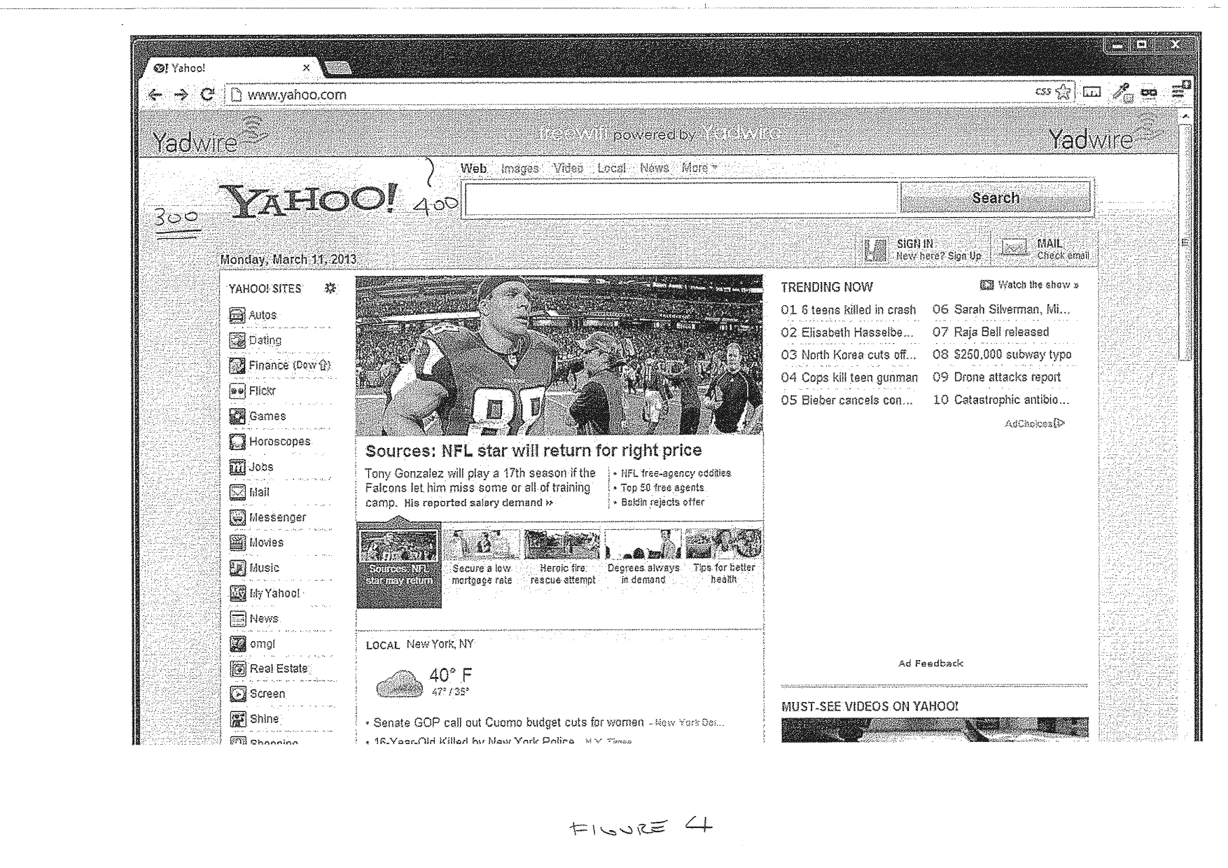

d. a strip may be added at the top of each web page. The strip may include a thin band of HTML and may include text (e.g. “Wi-Fi sponsored by”) and logos, or other textual and visual images, for example, as described further on below with reference to FIG. 4.

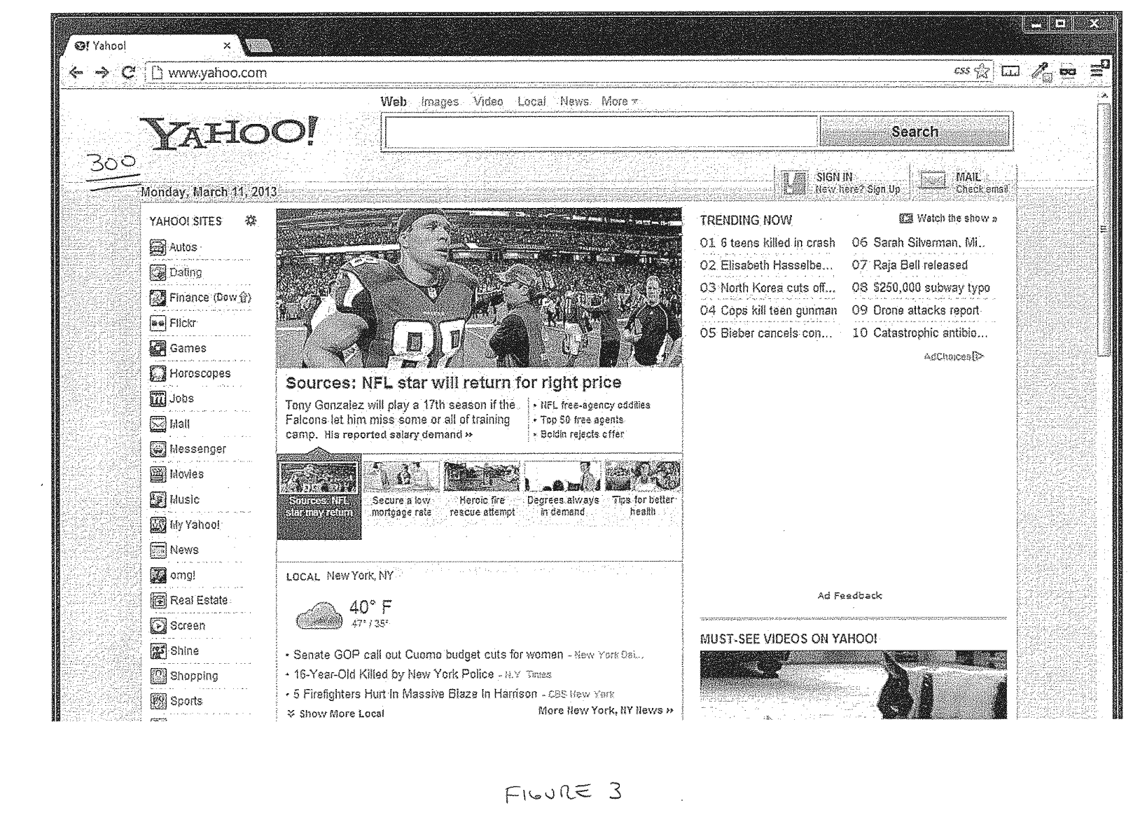

Reference is now made to FIGS. 3-6B which schematically illustrate an exemplary web browser page 300 before displayable content insertion and in various modes of displayable content insertion using system 100, according to exemplary embodiments of the present invention.

In FIG. 4 web browser page 300 following initial displayable content insertion of a strip 400 on a top section of the page. Strip 400 may be an HTML strip. A purpose of strip 400 is to identify the owner of router 108 by displaying this information inside the strip. Displaying of strip 400 may be predetermined and may be controlled by displayable content provider 102 (e.g. display of the strip may be enabled or disabled through server 104).

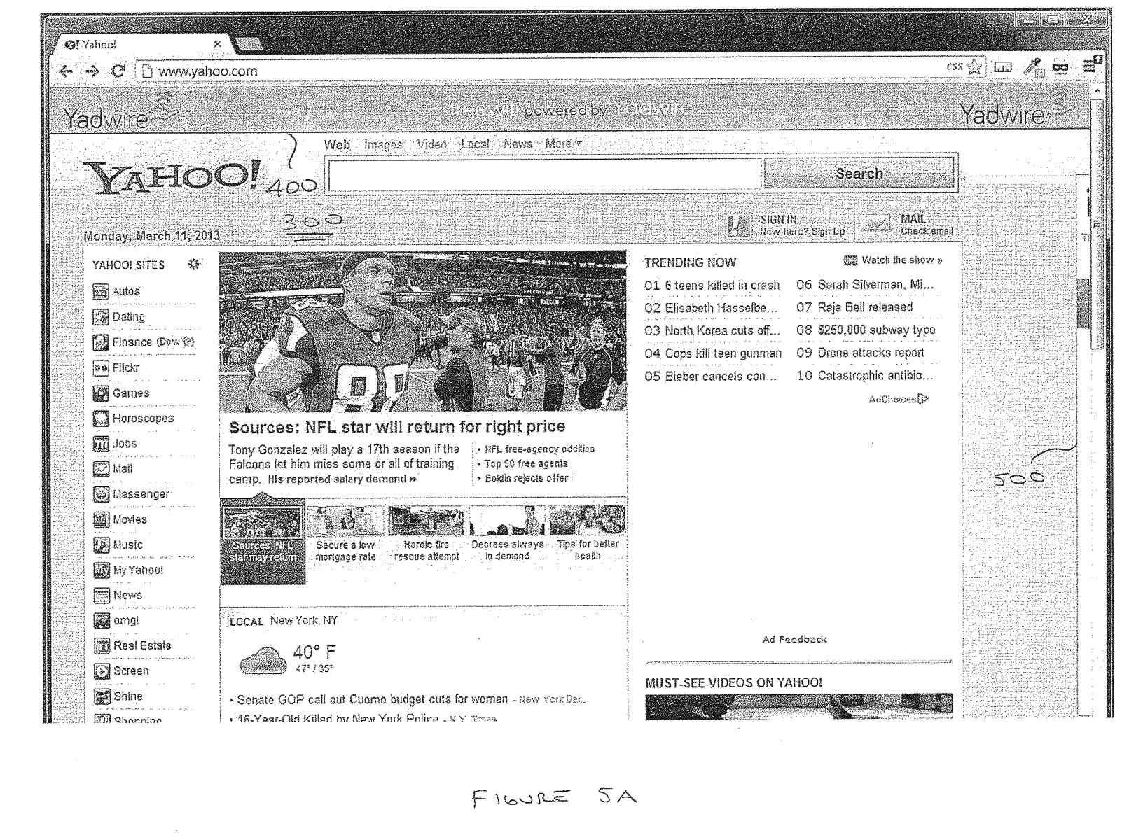

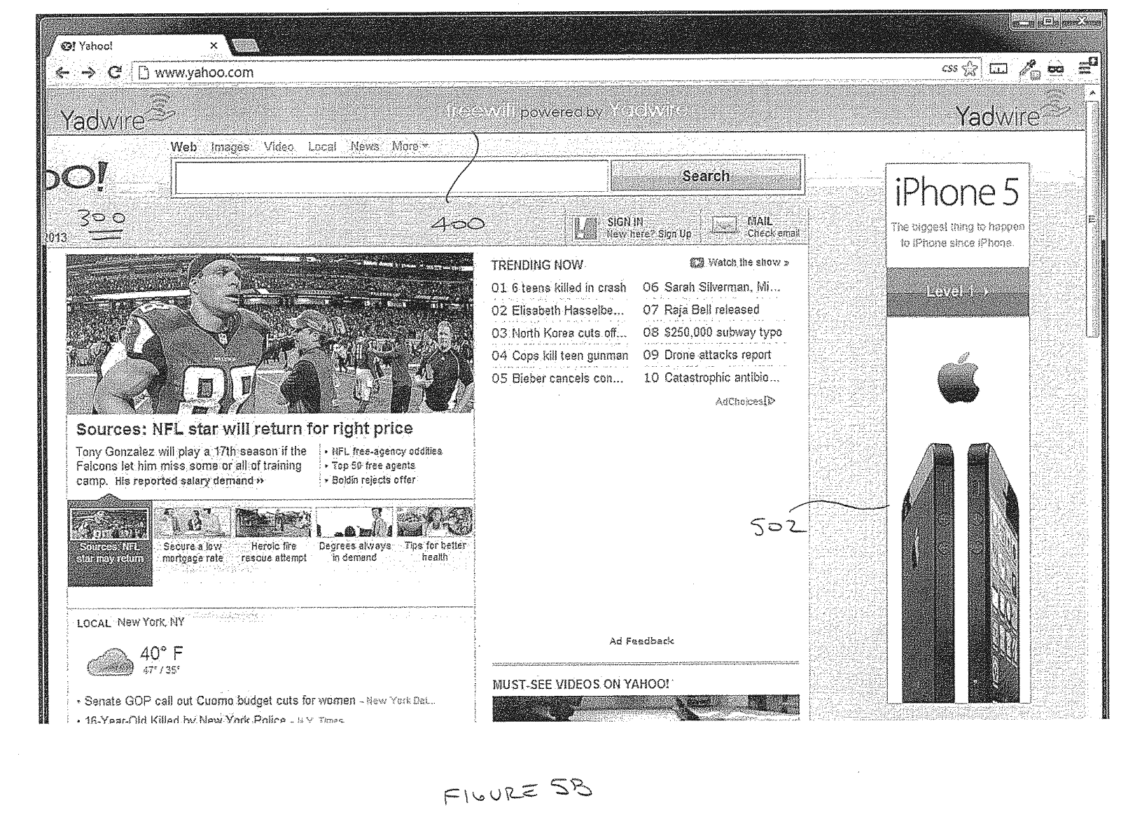

In FIG. 5A web browser page 300 is shown with HTML strip 400 in the top section of the page and a displayable content portion 500 slowly being inserted on the right side of the web page. In FIG. 5B, web browser page 300 is shown with HTML strip 400 in the top section of the page and displayable content portion 500 in FIG. 5A having fully been inserted on the right side of the web page, and shown as displayable content 502.

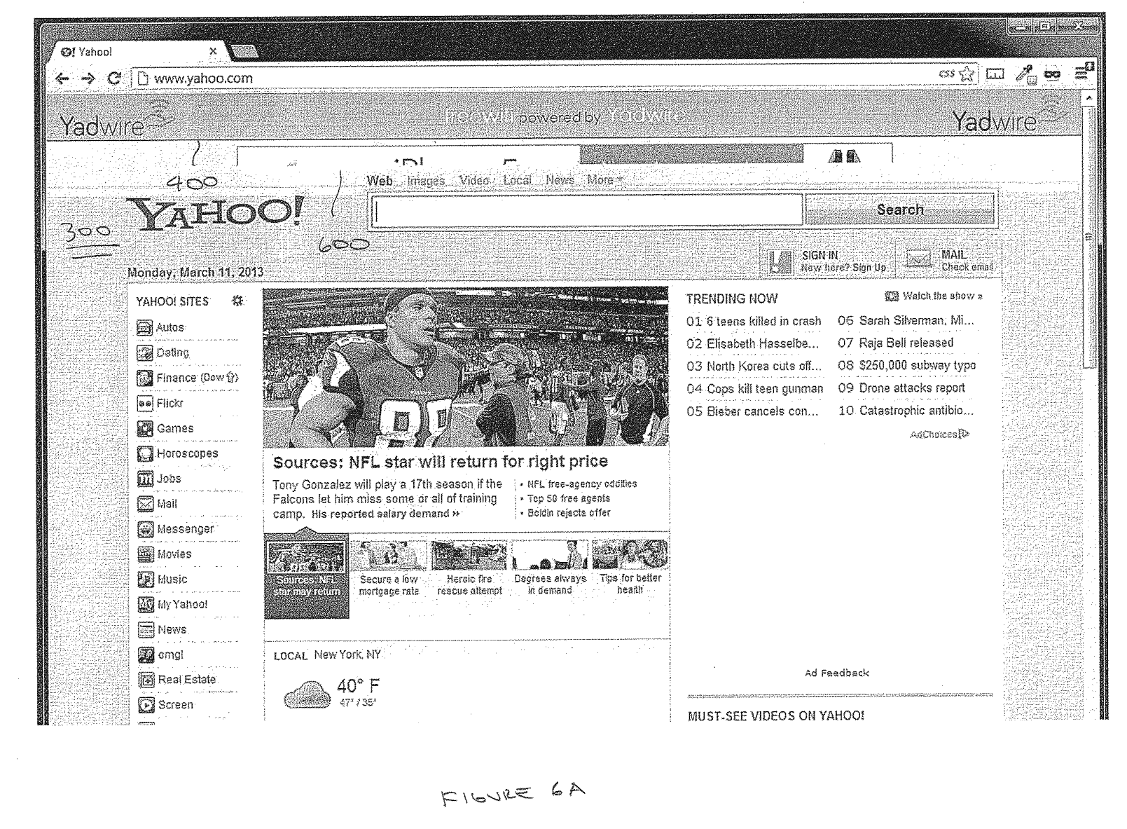

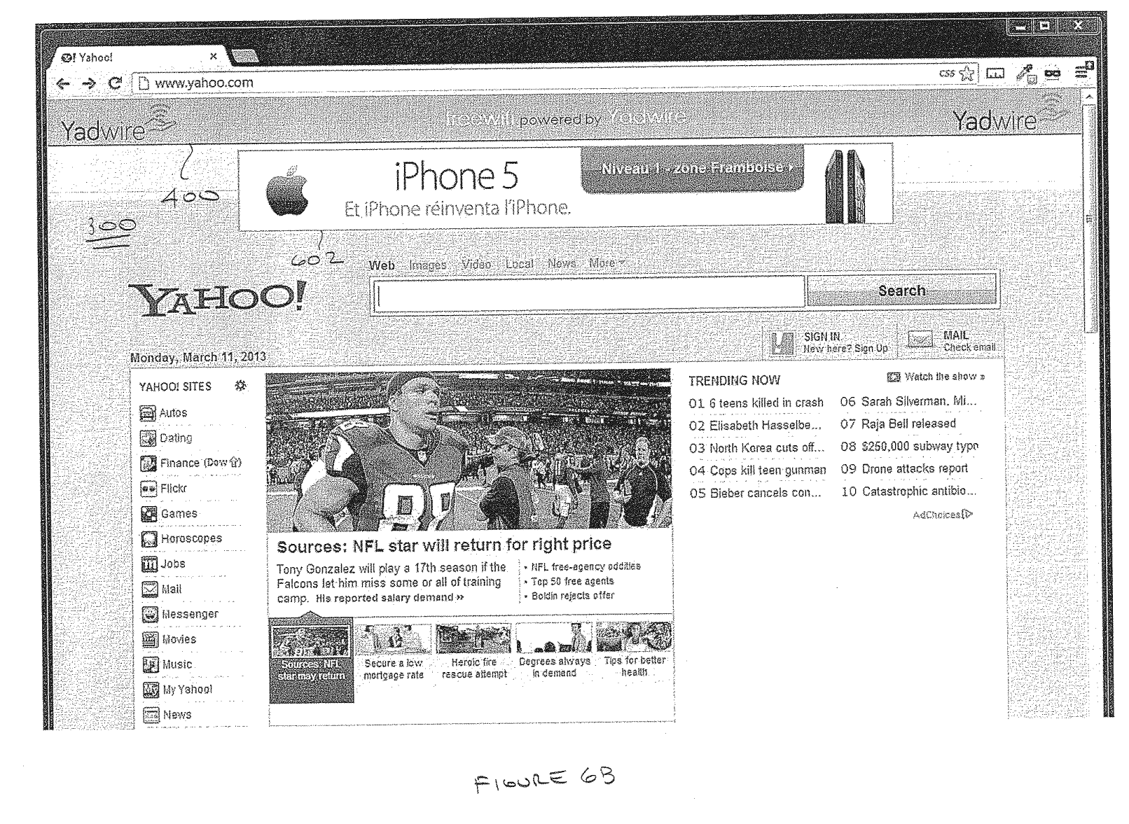

In FIG. 6A web browser page 300 is shown with HTML strip 400 in the top section of the page and a displayable content portion 600 slowly being inserted on the top side of the web page below the strip. In FIG. 6B, web browser page 300 is shown with HTML strip 400 in the top section of the page and displayable content portion 600 in FIG. 6A having fully been inserted on the top side of the web page below the strip, and shown as displayable content 602.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for inserting displayable content into a web page for displaying on a communication device comprising:
a displayable content provider in communication with the communication device over a communication network and operable to adjust a display format of the displayable content responsive to a call from the communication device; and
a communication network access device connecting the communication device to said communication network and including an injection unit to inject calling instructions into the web page prior to displaying the web page on the communication device.

2. A system according to claim 1 wherein said displayable content provider comprises a server.

3. A system according to claim 1 wherein said displayable content provider comprises a database.

4. A system according to claim 1 wherein said displayable content provider is operable to detect a display size of the communication device.

5. A system according to claim 1 wherein said displayable content provider is operable to detect a width size of the web page.

6. A system according to claim 1 wherein said communication network access device is a router.

7. A system according to claim 1 wherein said communication network access device communicates with the communication device over a wireless network.

8. A system according to claim 1 wherein said communication network comprises the Internet.

9. A system according to claim 1 wherein said calling instructions comprise a MAC (media access control) address of said communication network access device.

10. A method of inserting displayable content into a webpage for displaying on a communication device comprising:
requesting a web page from a web site;
intercepting the requested web page;
injecting into the web page calling instructions to a displayable content provider; and
displaying the requested web page on the communication device following injection of the calling instructions.

11. A method according to claim 10 further comprising
calling said displayable content provider;
determining a type of communication device responsive to said calling;
adjusting a display format of the displayable content responsive to said determining; and
inserting said displayable content into the requested webpage displayed on the communication device.

12. A method according to claim 10 further comprising said displayable content provider determining a display size of the communication device.

13. A method according to claim 12 further comprising said displayable content provider determining a font size of the displayable content responsive to said determining said display size.

14. A method according to claim 10 further comprising said displayable content provider determining a width of the requested web page.

15. A method according to claim 10 further comprising inserting into said calling instructions a MAC address of a communication network access device.

16. A method according to claim 10 wherein inserting said displayable content comprises inserting an HTML strip into the requested web page.

17. A method according to claim 10 wherein said displayable content is inserted on a side of the web page.

18. A method according to claim 10 wherein said displayable content is inserted above the web page.

19. A communication network access device for connecting a communication device to a communication network and comprising an injection unit for injecting calling instruction into a web page prior to displaying said web page on the communication device.

20. A communication network access device according to claim 19 comprising a router.

21. A communication network access device according to claim 19 comprising means to communicate with the communication device over a wireless network.
